(19) United States
(12) Patent Application Publication
(10) Pub. No.: US 2003/0126089 A1
(43) Pub. Date: Jul. 3, 2003

(54) Conversation method, device, program and computer-readable recording medium on which conversation program is recorded

(75) Inventors: Toshiyuki Fukuoka, Kawasaki (JP); Ryosuke Miyata, Kawasaki (JP); Koichi Murakami, Kawasaki (JP); Eiji Kitagawa, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/124,374

(22) Filed: Apr. 18, 2002

(30) Foreign Application Priority Data
Dec. 28, 2001 (JP) 2001-400675

(51) Int. Cl. G06F 17/60; H04L 9/00; H04K 1/00

(52) U.S. Cl. 705/54

(57) ABSTRACT

a) Predicting, by conversation information, context patterns that can possibly occur in future, evaluating the predicted context patterns according to the rating criteria, b) selecting a system message which is to be output next among a highly evaluated context pattern, and outputting the system message, c) selecting at least one user message that is among the user messages correspond to the system message and that is included in the conversation information, and outputing the user message, d) accepting selection of any one of the user message, e) deciding the next position of a marker that shows current topic according to the selected user message, f) repeating the step a) to e).

### BACKGROUND OF THE INVENTION

1. Technical Field

The present invention relates to technology by which fellow business users who operate computers have conversations with the computers to sell, search for, and inquire about merchandise or services for their customers.

2. Description of Related Art

Various conversation systems are offered as systems that let users utilizing computers sell, search for, and inquire about merchandise or services. Most of these conversation systems are configured so that they can respond to user input, such as question input and designation of options. A general way to respond to user input is to search for a response using the user's input as a key.

Meanwhile, game systems are offered as systems that let users have conversations with computers. In such conversations, a user answers in response to a question from a computer by designating an option or solving a riddle. This kind of conversation is possible under the condition that options by which a user answers in response to the questions from a computer are limited and context patterns are previously stored in the computer. Each context pattern is a possible scenario that consists of series of questions from the computer and options for answering the questions.

When a conversation system responds to an instance of user input using the input as a key, the conversation between the user and the conversation system basically ends after the user-input instance and the system's response to it. Even if the conversation system accepts another user-input instance and likewise responds, there will be no relationships among the separate combinations of user-input instances and the system's respective responses. Accordingly, this kind of conversation system cannot conduct conversations that have contextual qualities, as do those between humans. Moreover, the content of the conversation tends to be rather boring for a user who is in a conversation with the system. This is because the conversation is led by the user's input, and the content of the output from the conversation system is passive. Meanwhile, considering such conversation as that in the above-mentioned game systems-conversation based on preset options for users to answer-the longer the preset conversation grows, the more complex its structure will become. This results in severe limits on a user's answering options, lack of variety in the options, and repetition of similar conversations.

In short, a conversation system that conducts conversations having a contextual character and that performs effective information exchange has not been offered. If such a conversation system could lead the conversation to a specific result, the system could be effectively utilized for searching or inquiring about merchandise or services through a computer.

### SUMMARY OF THE INVENTION

An object of the present invention is for conversation utilizing a computer to provide technology in order to conduct natural conversations between the computer and a user. Another object of the present invention is for conversation utilizing a computer to provide technology that is effective in, for example, selling, searching for, and inquiring about merchandise or services.

The invention in a first aspect is a conversation method for conducting conversations between a computer and a user who operates the computer. This method includes: a topic net storing step of storing a topic net linking a plurality of topics; a conversation information storing step of storing conversation information including at least one system message that is a message from the computer, at least one user message that is a message from the user and that corresponds to the system message, and a correspondence between a position in the topic net and the system message and/or the user message; a messaging step including a sub-step of creating potential context patterns based upon a position in the topic net of a first marker indicating a current topic in the conversation, a sub-step of selecting at least one context pattern from the created context patterns, a sub-step of selecting a system message based upon the selected context pattern and outputting it; an option outputting step including a sub-step of selecting at least one user message based upon the position in the topic net correspondent to the selected system message, and a sub-step of outputting the selected user message; a selection accepting step of accepting selection of any one of the selected user messages; a decision making step of deciding the first marker's next position in the topic net; and an iterating step of iterating said messaging step, said option outputting step, said selection step, and said decision making step.

This conversation method executes the conversation by moving marker(s) in the topic net and outputting system messages corresponding to the topic net. An output system message is decided by selecting one of context patterns that can occur in the future and that are predicted based on the marker's current position. To give an example of a way of selecting a system message: rating all context patterns, selecting the most highly rated context pattern, and selecting a system message that should be output next in the context pattern.

In this method, a topic net, for example, a topic net utilizing for searching merchandise or inquiring about merchandise, preferably has node structure. In this node structure, nodes are linked and form tree shape widening from the beginning side of the conversation (upstream-end) into the ending side of the conversation (downstream-end). In this kind of a topic net, upstream-end nodes indicate generic or overall topics compared to downstream-end nodes. Conversely, downstream-end nodes indicate more specific or special topics compared to upstream-end nodes.

A second aspect of the invention is the conversation method as set forth in the forgoing first aspect, wherein the method further including: a marker creating step of creating a second marker at any position in the topic net, wherein the second marker is independent of the first marker; an conversation executing step of executing at least two conversational exchanges on each of the first marker and the second marker, by executing said messaging step, said option outputting step, said selection accepting step, said decision making step, and said repeating step.

Second and third topics are generated by creating further markers. For the topic corresponding to each marker, an in-context set of conversational exchanges is executed independently. Several conversational-exchange sets may be alternately executed, or may be executed simultaneously. In this way, natural conversation, like conversation between humans, is executed in such a way that the conversation diverges from its original topic and converges back to it again, lending it a natural context.

To give an example of a way of creating the second marker, creating the second marker in the case two context patterns are selected among the created context patterns may be cited. Separately executing two sets of conversational exchanges sometimes results in that each marker for the conversational-exchange sets converges at the same position in the topic net. This means each topic of the conversational-exchange sets becomes the same. Two sets of conversational exchanges converge, i.e., they are merged into one in this case, preferably.

To give another example of the method of creating the second marker, accepting an instruction of creation from the user may be cited. For example, suppose that travel destination and travel purpose are selected as topics by a user in a case in which the user wants to search for a travel package to suit for his/her taste. Then, two markers are created, and two conversational exchanges about the topics corresponding to the markers are executed.

A preferable aspect of the invention is the conversation method in the forgoing first aspect, wherein the conversation information further includes at least one message type showing the classification of a system message or the classification of a user message, wherein: said messaging step creates the context patterns based upon message types; and said option outputting step outputs a user message whose message type meets the system message's message type, the user message among the user messages corresponding to the system message.

To give examples of message types, assertive explanation, normal explanation, specific free question, proposal, user's agreement, user's denial, user's selection may be cited. Taking message type into account avoids to combine a certain system message with a user message that a user will not select for the response to the system message when the context patterns are created. For example, a user message whose message type is user's agreement or user's denial is not combined with a system message whose message type is specific free question. Likewise, among the user messages corresponding to a system message that is to be output, the user messages whose message types are not appropriate for the system message are not output as options for the user.

Another aspect is the conversation method said forth in the forgoing first aspect, wherein the method further includes: a criteria storing step of storing a rating criteria for evaluating the context patterns; and said messaging step evaluates created context patterns according to the rating criteria and selects at least one context pattern based upon the rating results.

The following are examples of rating criteria wherein several rules are predetermined and points are given to the context pattern if it satisfies with a rule.

Rule 1: if conversation has been lead to an aimed topic under the condition that the total number of system messages and user messages in the conversation is ten or less, then twenty points are given to a context pattern.

Rule 2: if four or more system messages are consecutively output based on the same marker, then six points are given to a context pattern.

Rule 3: if at least two markers are merged into one in a context pattern, then it is given five points.

Finally at least one context pattern is selected based upon total points. The context pattern having the highest total points may be selected. However, the method of selecting the context pattern(s) is not limited for this method. For example, a plurality of context patterns may be selected in the case there is a narrow difference in their total points.

Another aspect is the conversation method set forth in the forgoing first aspect, wherein said messaging step creates context patterns that consist of system messages and user messages and that total number of system messages and user messages is n (n≧2, an integral number).

The value of n is not particularly limited. The higher the value of n becomes, the heavier the load of creating context patterns becomes since the number of context patterns increases. On the other hand, too small value of n makes it difficult to evaluate context patterns appropriately. The value of n is preferably decided taking these aspects and complexity of the topic net into account.

A third aspect of this invention provides conversation device utilized for a computer and performing conversation between the computer and a user who operates it. This conversation device comprises following means: a topic net storing means for storing a topic net linking a plurality of topics; a conversation information storing means for storing conversation information including at least one system message that is a message from the computer, at least one user message that is a message from the user and that is a message corresponding to the system message, a correspondence between a position in the topic net and the system message and/or the user message; a messaging means for creating context patterns that possibly occur based upon a position in the topic net of a first marker showing a current topic in the conversation, selecting at least one context pattern from the created context patterns, and selecting a system message based upon the selected context pattern and outputting it; an option outputting means for selecting at least one user message based upon the position in the topic net correspondent to the selected system message, and outputting the selecting user message; a selection accepting means for accepting selection of any one of the selected user message; a decision making means for deciding the first marker's next position in the topic net; a repeating means for let said messaging means, said option outputting means, said selection means and said decision making means execute repeatedly.

The forth aspect of the invention provides a computer product utilized by a computer for making the computer function as said conversation device as set forth in the foregoing aspect.

The invention in a fifth aspect is a computer-readable recording medium on which is recorded a conversation program executing conversation between a computer and a user who operates it. This conversation program executes the conversation method set forth in the forgoing first aspect. As example of this recording media herein, flexible discs, hard disks, semiconductor memory, CD-ROMs, DVDs, magneto-optical discs (MOs), and other computer-read/writable recording media may be cited.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a configuration of the conversation system in a first embodiment example;

FIG. 2 is an explanatory diagram showing an example of the topic net;

FIG. 3 is an explanatory diagram showing an example of a conversation log;

FIG. 4 is an explanatory diagram showing a continuation of the conversation log in FIG. 3;

FIG. 5 is an explanatory diagram showing details from the topic net in FIG. 2;

FIG. 6 is an explanatory diagram showing an example of conversation information correlated with the topic “Italy” in the topic net of FIG. 5;

FIG. 7 is an explanatory diagram showing an example of conversation information correlated with the “Italy→Rome” link in the topic net of FIG. 5;

FIG. 8 is an explanatory diagram showing an example of conversation information correlated with the topic “Rome” in the topic net FIG. 5;

FIG. 9 is an explanatory diagram of a topic net in which a plurality of markers is established;

FIG. 10 is a display example of system messages, user messages, and a conversation log;

FIG. 11 is an example of a screen for accepting selection of topic by a user;

FIG. 12 is an explanatory diagram indicating how context patterns are created;

FIG. 13 is an explanatory diagram showing some examples of context patterns;

FIG. 14 is an explanatory diagram showing an example of rating criteria;

FIG. 15 is an explanatory diagram indicating rating results according to the rating criteria in FIG. 14;

FIG. 16 is a flowchart illustrating the flow of a conversation-executing routine.

### DETAILED DESCRIPTION OF THE PREFERRED EMBODIMENTS

Overall Configuration

In the present invention, conversation between a computer and a user who operates the computer is performed. Herein, a “topic net” comprises a plurality of topics, a plurality of links connecting topics, and topic IDs for identifying each topic. If a topic net with the aim of searching for merchandise is established, the topics indicate subjects relating to the merchandise such as characteristics of the merchandise, keywords for searching for the merchandise, and the like. More concretely, if a topic net with the aim of searching for travel packages is established, the topics in the topic net are destination, travel purpose, travel time, and the like. A link connecting two topics expresses an upstream-end/downstream-end relationship.

The conversation method in the present invention conducts conversations by utilizing, in addition to the topic net, rating criteria and conversation information pertaining to the topic net. The conversation method in the present invention is summarized as follows.

1) Predicting, from conversation information, context patterns that can possibly occur in the future, evaluating the predicted context patterns according to the rating criteria, selecting a system message which is to be output next from a context pattern with a high rating, and outputting the system message;

2) Selecting at least one user message that is among the user messages corresponding to the system message and that is included in the conversation information, and outputting the user message;

3) Accepting selection of any one of the user messages;

4) Deciding according to the selected user message the next position of a marker that indicates the current topic; and

5) Repeating steps 1 through 4.

Herein, a “system message” is a message from the computer to the user. A “user message” is an option that a user can select as a response to a system message.

First Embodiment Example

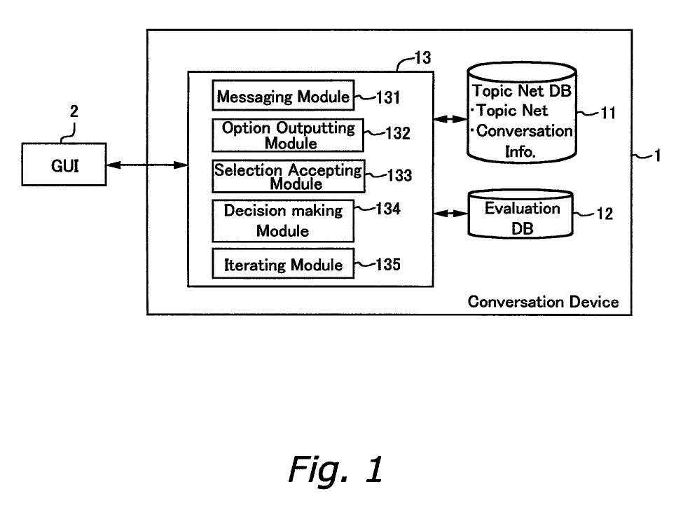

Next, the first embodiment example of the present example will be explained. In this embodiment, conversation utilizing a topic net is executed between a conversation system shown in FIG. 1 and a user who operates it. FIG. 1 is a block diagram illustrating the functional configuration of the conversation system. The conversation system includes a conversation device 1 and a GUI (Graphical User Interface) 2. The conversation device 1 may be actualized by a computer. On the hard disk of the conversation device 1, a topic net database (topic storing means) 11, a rating criteria database 12 (criteria means) are stored. The topic net DB 11 stores a topic net and conversation information. The rating criteria DB 12 stores rating criteria for evaluating context patterns that can occur in the future. These databases may be stored on the hard disk of a computer with which the conversation device 1 can communicate. The CPU in the conversation device 1 functions as a control unit 13. The control unit 13 includes: a messaging module 131 that is an example of messaging means; an option outputting module 132 that is an example of option outputting means; a selection accepting module 133 that is an example of selection accepting means; a deciding module 134 that is an example of decision making means; and an iterating module 135 that is an example of repeating means.

The GUI 2 may be actualized by a computer. A computer may function as the conversation device 1 and the GUI 2, or each of different computers may function as the conversation device 1 and the GUI 2. The GUI 2 displays system messages, user messages, and conversation logs. Following is a detailed explanation of the conversation system. Firstly, the basic concept behind conversation utilizing the topic net will be explained; secondly how to a conversation is conducted will be explained. Details of the conversation system will be given in these explanations.

(1) Basic Concept Behind Conversation Utilizing Topic Net

(1-1) Topic Net

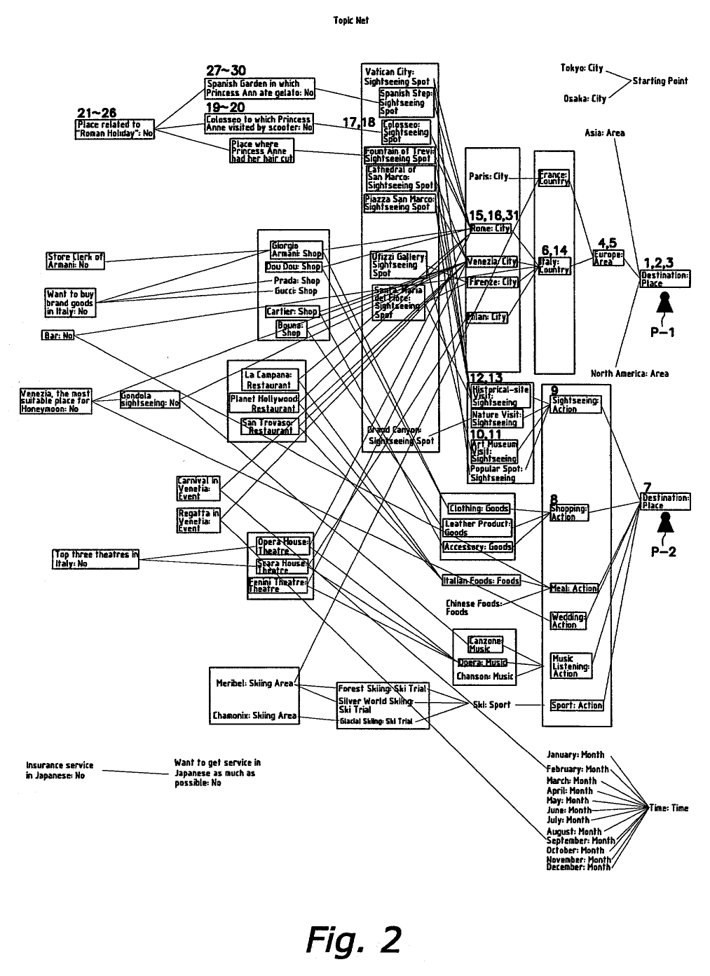

FIG. 2 is an explanatory diagram showing an example of a topic net stored in the topic net DB 11. The topic net is created according to the aim for which it is used and category of merchandise such as searching for or inquiring about merchandise. The topic net in this example is in the aim of planning travel itineraries suitable for users. In this topic net, each node is linked so that the topic net forms a tree structure widening from upstream to downstream. However, links in some topic nets do not define an upstream-end/downstream-end orientation. At least one marker is established in the topic net by the deciding module 134 in the control unit 13. Each marker corresponds to a node, and indicates the current topic in each set of conversational exchanges. Two markers, P-1 and P-2, are set in the topic net in FIG. 2. The markers will be described later.

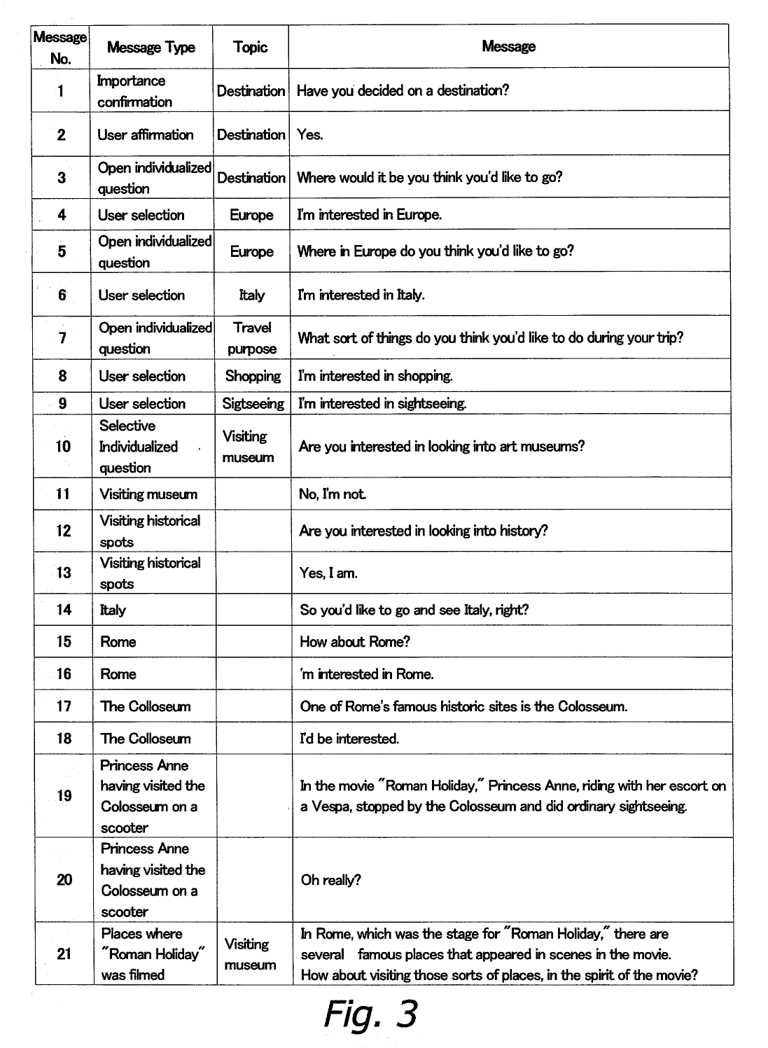

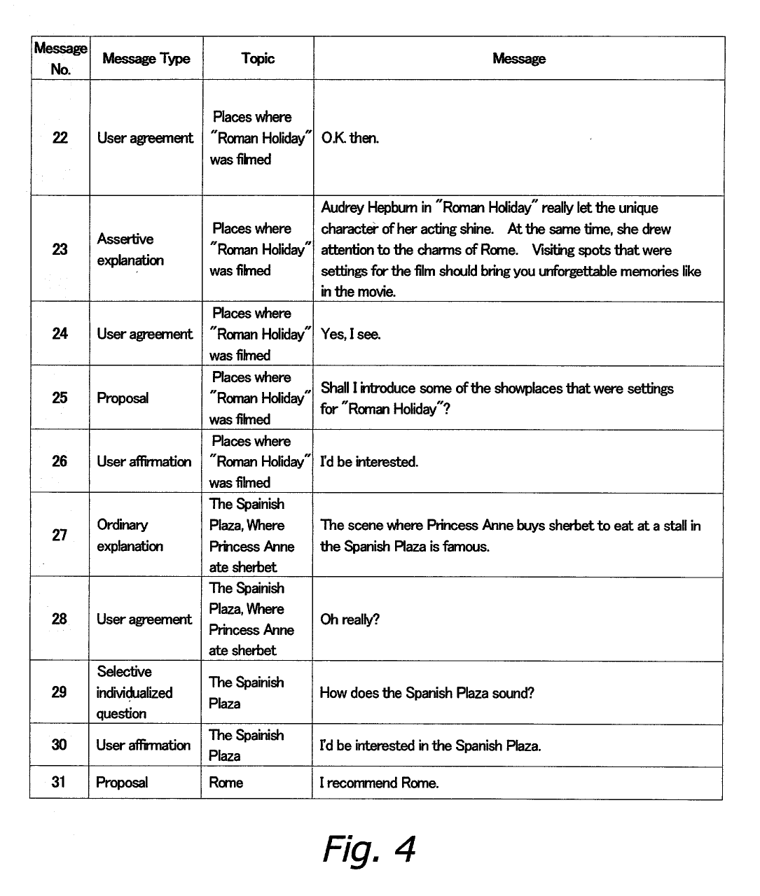

FIGS. 3 and 4 illustrate an example of log of a conversation that has been conducted according to the topic net described in FIG. 2. The conversation log is temporally stored in an operational memory such as a RAM (not shown in the figure), and is output on GUI 2. The conversation log may be stored on the hard disk in the conversation device 1, or on other recording media. The conversation log in these figures sets out a conversation performed in order to plan a user's travel destination. A conversation transition from “destination,” which is the upstream-end topic, to “Rome,” which is the downstream-end topic, is shown in this conversation log. It may be said that a comprehensive topic, destination, converges to the more specific topic in the conversation.

The conversation log may include not only messages in the conversation but other information. Herein it contains a message number, which is a serial number that is assigned to each of the messages in the conversation. The conversation log also includes a message type for each message and topic. The message type is attribute information indicating message classification, and is set in the conversation information. The topic corresponds to a node that a marker is indicating. In other words, changes of topics in the conversation log represent the marker's topic-net movement in the conversation.

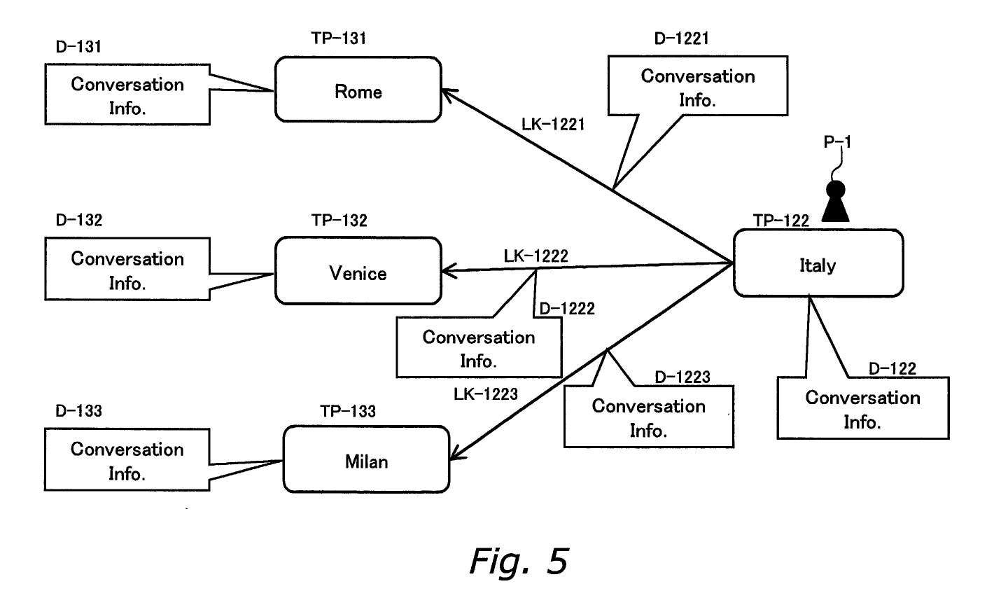

FIG. 5 is an explanatory diagram showing details from the topic net of FIG. 2. A part of the topic net in FIG. 2 is enlarged here. Each node in the topic net is identified by the topic ID (node identifier) “TP-131,” “ITP-132,”. . . . Each node corresponds to a topic. Each link is identified by a link ID (link identifier) “LK-122,” “LK-1222,”. . . . A link connects two topics and defines which one is the upstream-end and which one is the downstream-end. For instance, in FIG. 5, topic TP-122 and topic TP-131 are linked by link LK-1221. This link defines a direction from the topic “Italy” to the topic “Rome.” The upstream-end topic indicates more comprehensive content or a more generic subject compared to a downstream-end topic. On the other hand, a downstream-end topic indicates more specific content or a more concrete subject compared to an upstream-end topic. Connecting each node by links that have directions configures the topic net in a tree structure widening from the upstream-end to the downstream-end.

Conversation information that contains system messages and/or user messages is stored correlatively with each node and each link, although conversation information corresponding to a link may be stored correlatively with the node from which the link originates. A marker P-1, which indicates a topic corresponding to a current topic in a conversation, is set in the topic net. The marker P-1 moves along the links over the topic net according to changes of topic. System messages and user messages are output on the GIU 2 based on conversation information for nodes on which the marker P-1 is located, or conversation information for links originating from the nodes.

In the topic net, if topic A is linked with topics B, C . . . that are located downstream from topic A, topic A signifies a subject that is more comprehensive than topics B, C . . . and that is common to those topics B, C . . . . For instance, topic TP-122 “Italy” is linked to topic TP-131 “Rome,” topic TP-132 “Venice” and topic TP-133 “Milan,” which are more specific than the topic “Italy.” The topic “Italy” is common to “Rome,” “Venice,” and “Milan” and expresses a place that comprehends these three cities.

Conversely, if topic A is linked with topics B, C . . . that are located upstream from topic A, then topic A signifies a subject that is more specific than those of topics B, C . . . and that is common to those of topics B, C . . . . For instance, the topic “The Colosseum” is linked with the topics “Rome” and “visiting historical spots” that are on the upstream-end. The topic “The Colosseum” is common to “Rome” and “visiting historical spots,” and expresses a more specific or more concrete place than the other topics.

The above-mentioned topic net is not limited that in illustrated FIG. 2. The topic net is prepared according to the merchandise or services, and might be, for example a topic net for designing a travel plan, a topic net for searching for a personal computer suitable for a user, or a topic net for preparing a wedding party. The topic net DB 11 stores at least one topic net.

(1-2) Conversation Information

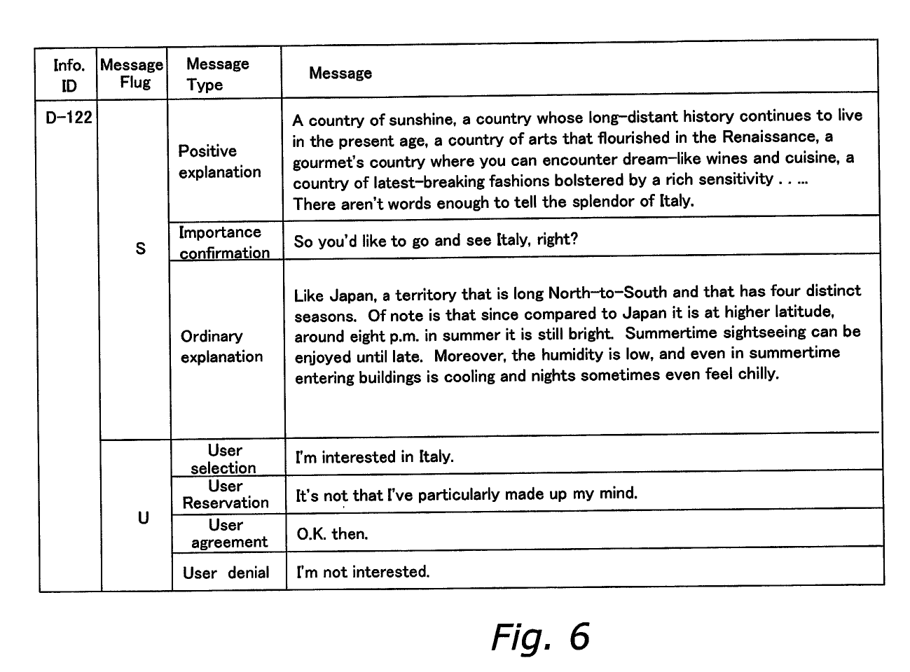

FIGS. 6, 7, and 8 illustrate explanatory diagrams of conversation information stored in the topic net DB 11. The conversation information is generated so that it is related to a node or a link in the topic net. The conversation information shown in these figures are examples of conversation information for the topic net on FIG. 5.

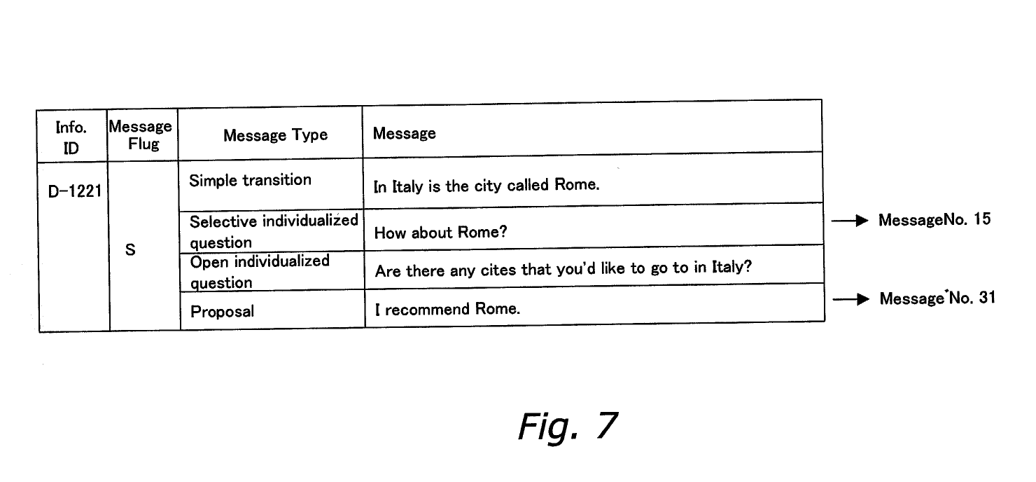

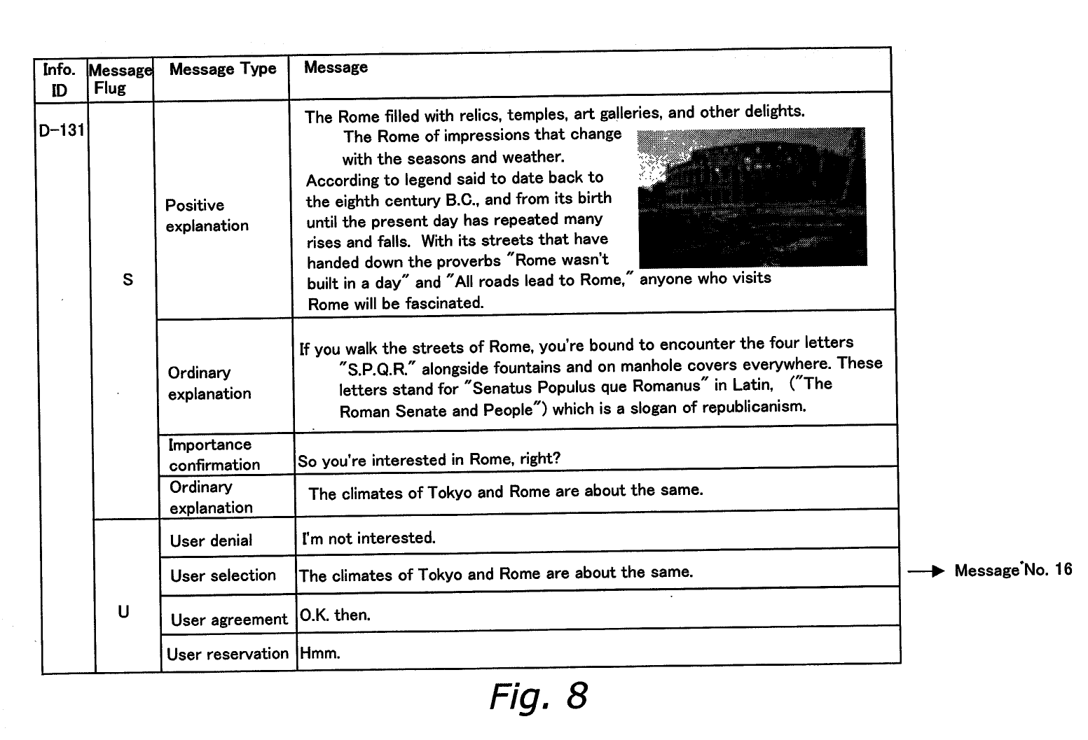

FIG. 6 sets forth conversation information correlated to node TP-122 (topic “Italy”). FIG. 7 sets forth conversation information correlated to link LK-1221 from the topic “Italy” to the topic “Rome.” FIG. 8 sets forth conversation information correlated to node TP-131 (topic “Rome”).

In these examples, conversation information is identified by an information ID. Each item of conversation information includes a message flag, a message type, and a message. A message flag is a flag that shows whether the message corresponding to the message flag is a system message from the system end or a user message as an option for the user. The message flag is not necessary in the case in which a judgement as to whether the message is a system message or user message can be made according to the message type.

The “message type” indicates the category of message, such as explanation, confirmation, agreement, denial, or selection. The message type is information that is not always necessary; however, it is preferably contained in the conversation information, since it is utilized for evaluating context patterns based on the rating criteria, which will be discussed in section 2-2. In the present embodiment example, the message types for system messages are presumed to be “positive explanation,” “important explanation,” “importance confirmation,” “ordinary explanation,” “simple transition,” “selective individualized question,” “open individualized question,” and “proposal.”Among these seven message types, “positive explanation,” “importance confirmation,” and “ordinary explanation,” in particular are message types that indicate properties of messages relating to topics, and may be treated as message types that are included in a node's conversation information.

The other four message types—i.e., “simple transition,” “selective individualized question,” “open individualized question,” and “proposal”—may be treated as message types that are contained in a link's conversation information, since these message types pertain to transition of topic. For example, node TP-233 (topic “Italy”) and node TP-131 (topic “Rome”) are related to conversation information that contains system messages having three node types. Link LK-1221 from “Italy” to “Rome” is correlated to conversation information that contains system messages having four link types. Of course, a plurality of messages may have the same message type in conversation information that is correlated to a node or a link.

In addition, four message types for user messages are presumed in the present embodiment example. They are “user selection,” “user reservation,” “user agreement,” and “user denial.” Hereinafter these message types are referred as “user types.” A user message is contained in a node's conversation information and not contained in a link's conversation information in the present embodiment. For example, the user messages in the conversation information for nodes TP-122 and TP-131 (“Italy” and “Rome”) contains all user types. However, the conversation information for link LK-1221 from “Italy” to “Rome” does not contain any user message. Any user message in response to this link's system messages is selected from user messages contained in conversation information correlated with link destination node TP-131 (topic “Rome”). Of course, a link's conversation information may include a user message.

Messages in conversation information are text messages for displaying as system messages, or is text messages for displaying as options in response to system messages. A message may contain not only a text message but also an image file, a voice file, a link to these kinds of files, or the like. For instance, the system message in the conversation information for “Rome” in FIG. 8 contains image data for sightseeing spots in Rome. Likewise, a system message for a node relating to a topic “concert ticket” may for example include audio data or image files of musicians performing programs the tickets are for.

(1-3) Marker Position and Displayed Message

A conversation using a topic net develops according a marker's movement in the topic net. As mentioned above, at least one marker is set on a node by the deciding module 134 in the control unit 13. A marker moves from node to node along the direction of a link in the present embodiment. A system message and a user message that are to be displayed change in accordance with the position of the marker in the topic net. FIG. 5 is referred to again to explain the relation between the position of a marker and a system message and a user message that are to be displayed.

A system message that is to be displayed is selected from the conversation information for a node on which a marker is located, or the conversation information for a link which originates form the node. For example, in FIG. 5, marker P-1 is located on node TP-122 (“Italy”). In this case a system message that is to be displayed is selected from conversation information items D-122, D-1221, D-1222, and D-1223 that are correlated to the node, or from three links originating from the node, and is displayed. The selection and the control of the display are executed by the messaging module 131.

A user message displayed as an option in response to the selected system message is part or all of the user messages contained in conversation information D-122, in the case in which the system message is selected from the node's conversation information D-122. If the system message is selected from the conversation information for one of the links, the user message is part or all of the user messages contained in the conversation information for the link destination node. For example, suppose that the system message is selected from conversation information D-1221 for link LK-1221, which is from “Italy” to “Rome”. In this case, at least one user message is selected from conversation information TP-131 that is correlated to the link destination node TP-131 (“Rome”).

One of the methods of selecting at least one user message in order to display it as an option is to select all of the user messages contained in conversation information D-131. However, another method is to select user messages whose user message type suits the selected system message. Examples of suitable combinations of message types that may be cited include: (1) in response to a “selective question” system message, selecting and displaying user messages that can answer the question; and (2) in response to an “explanation” system message, selecting user messages expressing such responses as user's agreement, denial, or not being able to understand. The responses herein are expressed by such user messages as “I see,” “I don't think so,” “I don't know.”

If a link's conversation information contains both system messages and user messages, user messages displayed in response to system messages can be selected from the link's user messages and/or the link destination node's user messages. Selecting and displaying at least one user message is controlled and executed by the option outputting module 132.

When any one of displayed user messages is selected by the user, the marker moves to the node whose conversation information contains the selected user message. The selection of a user message is accepted by the selection accepting module 133. Markers are moved by the deciding module 134.

(1-4) Pluralities of Markers and Marker Merging

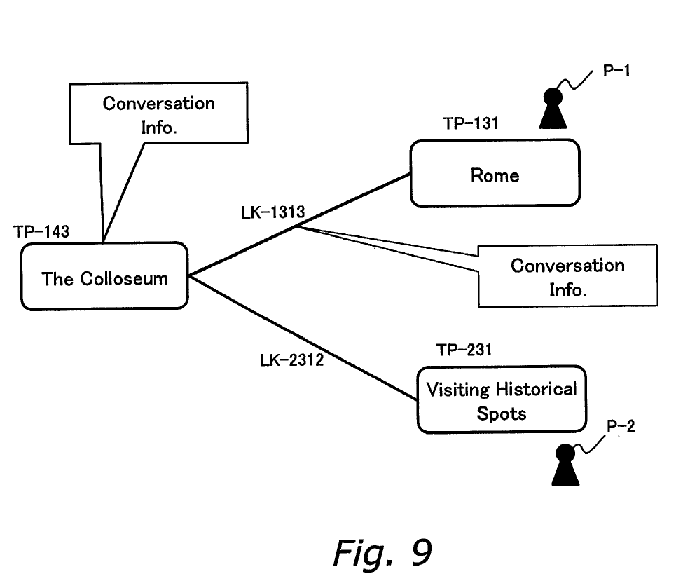

FIG. 9 is an explanatory diagram showing a plurality of markers in the topic net and merging of the markers. The number of markers set in the topic net is not limited to one. A plurality of markers may be set in a topic net by the deciding module 134 in the control unit 13 generating second and third markers. Each position of each marker indicates how much the set of conversational exchanges has developed along the topics indicated by the marker.

Suppose that marker P-1 (a first marker) is set on the topic “destination” and that marker P-2 (a second marker) is set on the topic “travel purpose” in FIG. 2. In this case, the first set of conversational exchanges develops from the topic “destination,” while the second set of conversational exchanges develops separately from the topic “travel purpose.”

FIG. 9 shows a situation in which two conversational-exchange sets are developing. In FIG. 9, marker P-1 (the first marker) is located on node TP-131 (topic “Rome”). This marker P-1 has moved from the topic “destination” (see FIG. 2) to the topic “Rome.” Meanwhile, marker P-2 (the second marker) is located on node TP-231 (topic “visiting historical spots”). This marker P-2 has moved from the topic “travel purpose (see FIG. 2) to the topic “visiting historical spots.” In this way, two conversational-exchange sets develop separately according to independent movements of the two markers. As a result, the computer can conduct a natural conversation like between human beings, in which topics deviate from each other or jump back and forth, and a natural contextual flow is created.

Several conversational-exchange sets developing separately sometimes converge into one. This happens when a plurality of markers moves to the same node in the topic net. For example, suppose that a user selects the user message “I'm interested in The Colosseum” in response to the system messages displayed in accordance with marker P-1 being located on node TP-131 (topic “Rome”). Then, marker P-1 moves to node TP-143 (topic “Colosseum”). Meanwhile, suppose that the user selects the user message “I'm interested in The Colosseum” in response to the system message displayed in accordance with marker P-2 being located on node TP-231 (topic “visiting historical spots”). Then, marker P-2 moves to node TP-143 (topic “The Colosseum”). The two markers P-1 and P-2 move to the same node TP-143 (topic “The Colosseum”) and merge into one marker. As mentioned above, the deciding module 134 merges a plurality of markers into one when these markers move to the same node in the topic net. This results in convergence in the conversation and makes it easier to lead the conversation to a conclusion.

(1-5) Conversation Display Examples

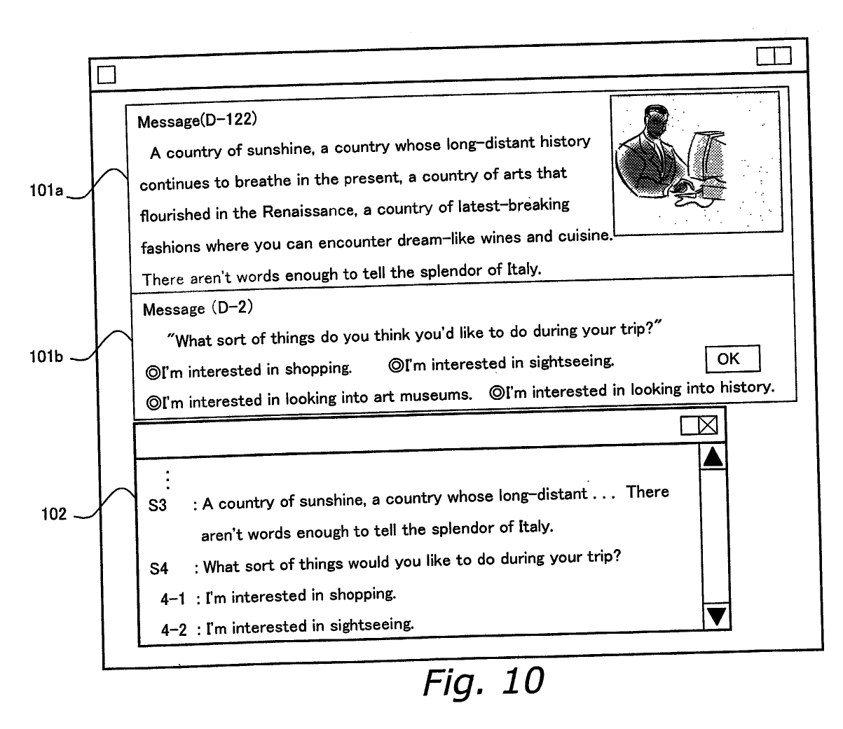

FIG. 10 is a display example of a conversation as displayed by the GUI 2. The messages are selected by the messaging module 131 and the option outputting module 132, and are displayed on the display by the GUI 2. This example illustrates a situation in which two markers are set in the topic net and two sets of conversational exchanges are developing. Message windows 101a, 101b are displayed on the display. Each message window is created in order to display each conversational-exchange set according to each marker. In FIG. 10, message window 101a illustrates a system message whose message type is “ordinary explanation.” Message window 101b illustrates a system message whose message type is “open individualized question,” and user messages that are suitable for answering in response to the system message. The user would select at least one user message in this example.

Log window 102 is also displayed on the display. Log window 102 shows a log of a conversation conducted between the user and the conversation system (see FIGS. 3 and 4).

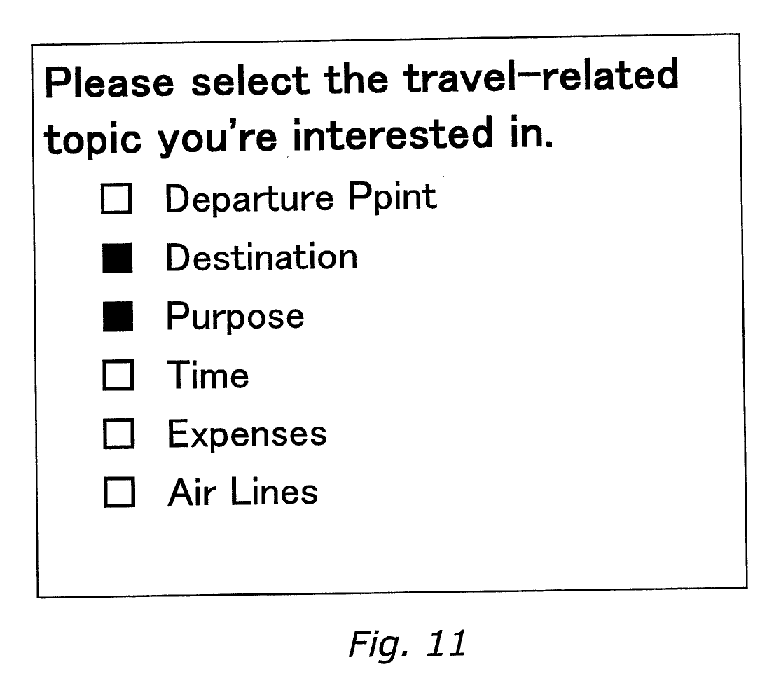

FIG. 11 shows an example of a screen for accepting selection of topics by a user. This screen is displayed at the beginning of a conversation, and accepts selection of one or a number of topics. Herein, the two topics “destination” and “travel purpose” have been selected. After selection of the topics, a number of message windows that is the number of selected topics are displayed, and the sets of conversational exchanges proceed. The selection of topics is accepted by the deciding module 134. Alternatively, the conversation device 1 can select the topics before the conversation starts.

(2) Method for Developing Conversation

A method for developing conversation utilizing the topic net will be explained with reference to the drawings.

(2-1) Generating Conversation Patterns

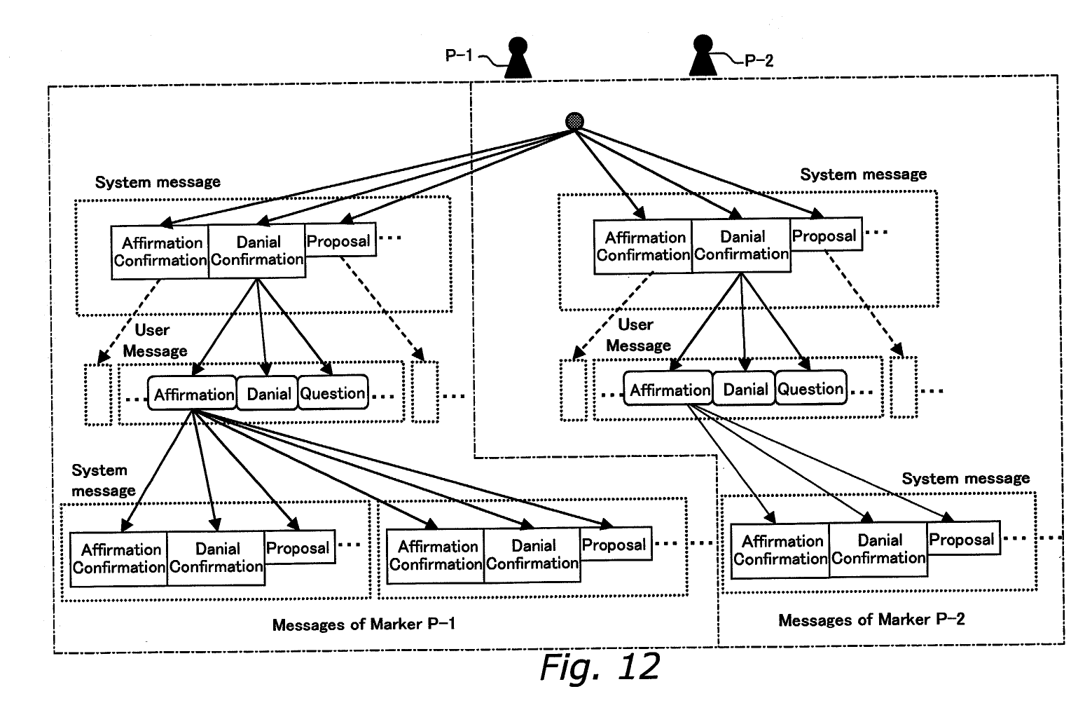

FIG. 12 is an explanatory diagram showing how context patterns are generated. Conversation patterns indicate where a current topic is heading. In other words, a context pattern is generated according to the current position of the marker (“current node” hereinafter), and to system messages and user messages for nodes and links that are downstream from the current node. Consequently, the number of context patterns that are generated will vary depending on how many times messages thenceforth are combined. FIG. 12 illustrates context patterns generated by predicting, and creating all possible combinations of, n future messages (n≧2, an integer). In this figure n=3 , but the value of n is not particularly limited. If the value of n is too high, the number of context patterns that should be generated increases, causing a heavy load on the computer. If the value of n is too small, the reliability of the context pattern rating results deteriorates. The value of n is chosen taking the structure of the topic net or the purpose of the topic net into consideration. Conversation patterns are generated per each marker. It is preferable that a context pattern consists of suitable combinations of system message types and user message types. This is also effective for decreasing the calculation burden of evaluating context patterns in instances in which many context patterns are generated. Conversation patterns are generated by the messaging module 131 based on a new current node when the marker moves from an old one.

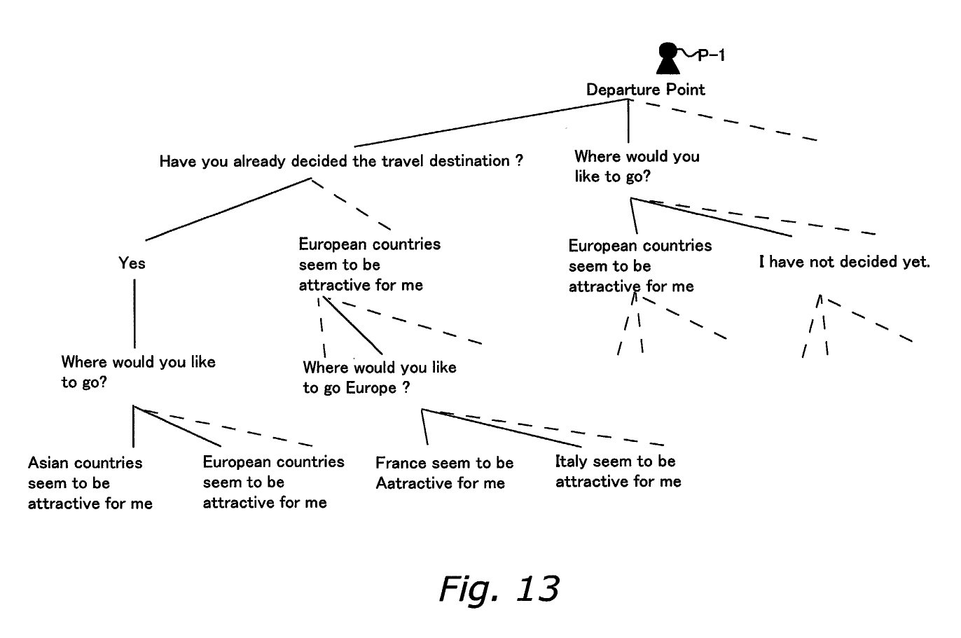

FIG. 13 shows an example of context patterns wherein n is 4. Suppose that the marker is located on the node whose topic is “destination” in the topic net of FIG. 2. In this diagram, context patterns are generated by predicting four future messages based on the current node. The following is one example of a context pattern.

First Conversation Pattern

S1: “Have you already decided on a travel destination?”

U2: “Yes, I have”

S3: “Where would you like to go?”

U4: “Asia sounds attractive to me.”

Here, “S” indicates system messages, and “U” indicates user messages. The number after “S” or “U” indicates the number of the message in succession from the current node.

The following is another example of a context pattern.

Second Conversation Pattern

S1: “Have you already decided on a travel destination?”

U2: “Yes, I have.”

S3: “Where would you like to go to?”

U4: “Europe sounds attractive to me.”

(2-2) Rating Criteria

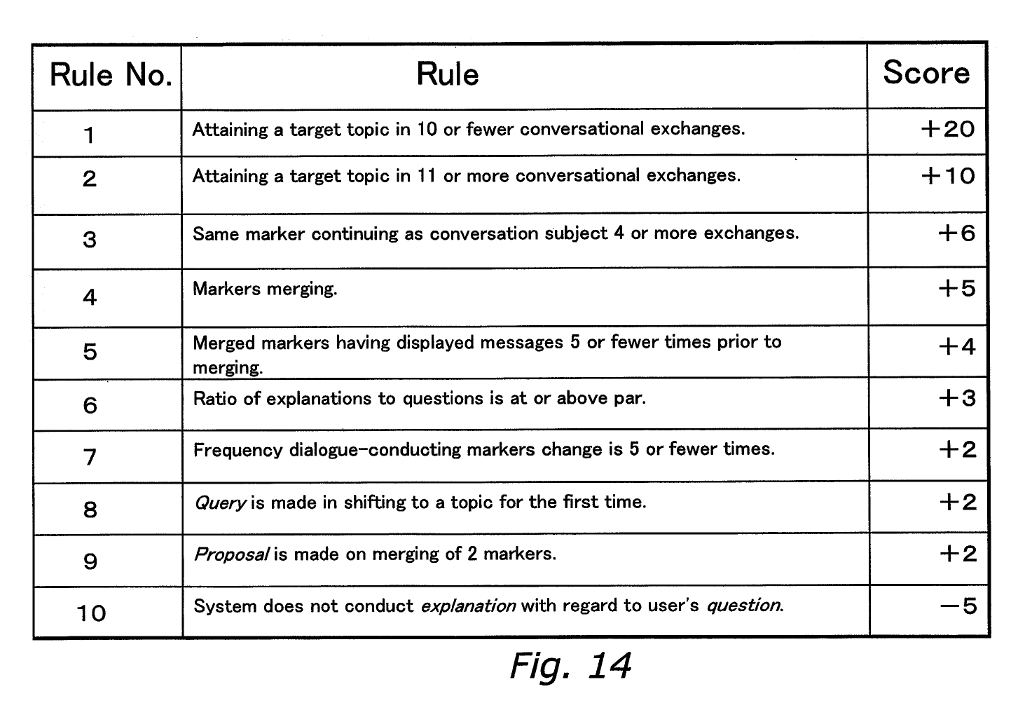

FIG. 14 is an explanatory diagram showing an example of rating criteria stored in the rating criteria DB 12. All generated context patterns are evaluated by the messaging module 131 based on the rating criteria. In FIG. 14, rules indicated by numbers 1 to 10 are established as rating criteria. Each rule is correlated with a score that is given to a context pattern if the context pattern satisfies the rule. A context pattern is evaluated based on the total score, which is the sum of the scores for the rules the context pattern satisfies. These rules will be explained in detail.

Rule No. 1: “If a context pattern including 10 or fewer messages leads to the conclusion sought, then the context pattern is given a score of 20.” In the present embodiment, if the total number of system messages and user messages is ten or fewer, and moreover the travel destination is decided in the context pattern, then the context pattern is given a score of 20.

Rule No. 2: “If a conversation including 11 or more messages reaches the conclusion sought, then the context pattern is given a score of 10.” For example, if the total number of system messages and user messages is eleven or more, and moreover the travel destination is decided in the context pattern, then the context pattern is given a score of 10.

Rule No. 3: “If four consecutive messages are displayed based on the same marker, then the context pattern is given a score of 6.” In other words, if a set of conversational exchanges is developed on a topic without jumping to another topic in the context pattern, then the context pattern is given a score of 6.

Rule No. 4: “If the markers merge into one in a context pattern, then it is given a score of 5.”

Rule No. 5: “If the merged markers correspond to messages displayed five or fewer times prior to merging, then the context pattern is given a score of 4.” In other words, if the merging of markers occurs not long after messages correlating to the markers have been displayed, then the context pattern is given a score of 4.

Rule No. 6: “If the ratio of explanations to questions is at or above a specified par, then the context pattern is given a score of 3.” In other words, if not only enough questions but also explanations are presented to the user in a context pattern, then the context pattern is given a score of 3.

Rule No. 7: “If the number of times conversation-directing markers are changed is five or fewer, then the context pattern is given a score of 2.” In other words, if the conversation-directing markers do not change very often in a conversation, then the context pattern is given a score of 2.

Rule No. 8: “If a question to the user is displayed when the topic is new in a context pattern, then the context pattern is given a score of 2.”

Rule No. 9: “If a proposal is displayed when a marker moves to a node on which another martker is located, then the context pattern is given a score of 2.”

Rule No. 10: “If no explanation is displayed in response to a question from the user in a context pattern, then the context pattern is given a score of minus 5.

Not only these rules, but also other rules for appropriately evaluating context patterns may be established as needed.

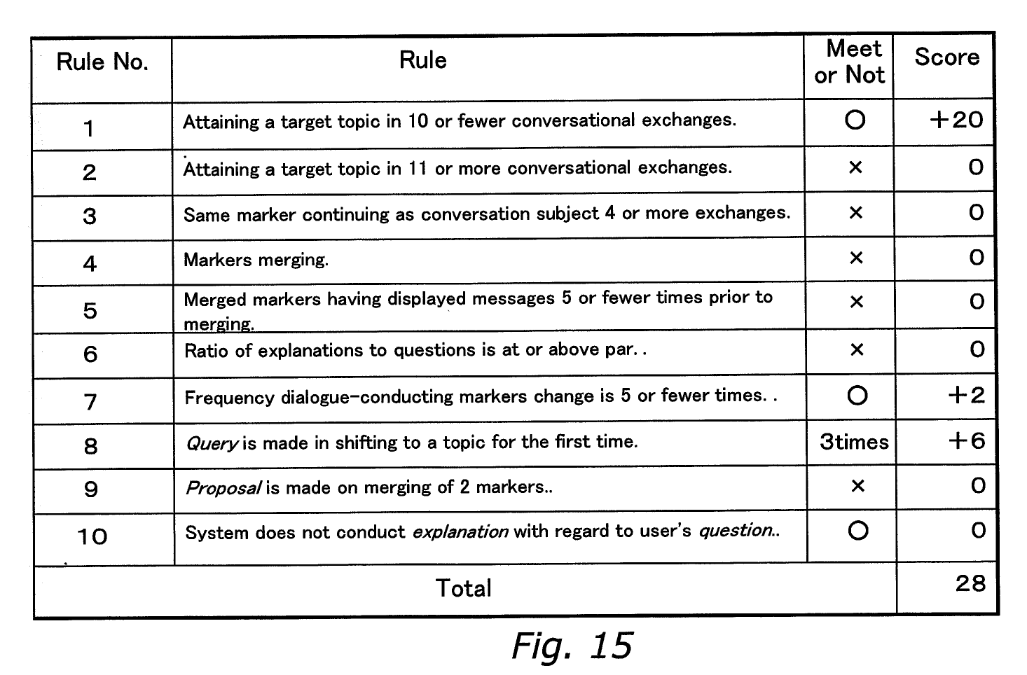

FIG. 15 is an example of a context pattern rating. For each context pattern, whether or not it satisfies each of the rules is judged, and scores from the rules a context pattern satisfies are assigned to the context pattern. The total score for a context pattern is calculated by summing up the scores for the rules that the context pattern satisfies. In this example, the context pattern satisfies Rule Nos. 1, 7, 8 and 10. The total score for the context pattern is 28. All context patterns generated are evaluated likewise.

A system message to be output as a next system message is decided based on the rating results for the context patterns. The next system message may be the next system message from the current node in the context pattern having the highest total score. Alternatively, the next message may be selected by: first, evaluating all context patterns that have been generated; second, grouping all system messages that are possible next messages; third, calculating the average total score for each group; fourth, selecting several groups whose average score is high and selecting the first system messages in the groups. In this case, topics increase, accompanying which message windows also increase. Selection of context patterns and system messages is executed by the messaging module 131.

At least one user message that corresponds to the selected system message is displayed. The displayed user message will differ according to whether the selected system message is contained in the conversation information for a node or for a link. Selection of the user message is executed by the option outputting module 132.

Referring once more to FIG. 13, further examples of context pattern selection and of message display will be explained. In FIG. 13, if the first context pattern has the highest score, “Have you already decided on a destination?” is selected as the next system message that is to be displayed. The user messages displayed as options in response to this system message are: “Yes, I have”; “Europe sounds attractive to me”; and the like.

Subsequent to the displaying of user messages, the marker(s) are moved according any user message selected; and context pattern generation based on the new current node, evaluation of the context patterns, selection and display of system messages and user messages, and marker(s) movement are executed. These steps are repeated by the iterating module 135, and a conversation based on a topic net develops.

(2-3) Conversation Developing Process

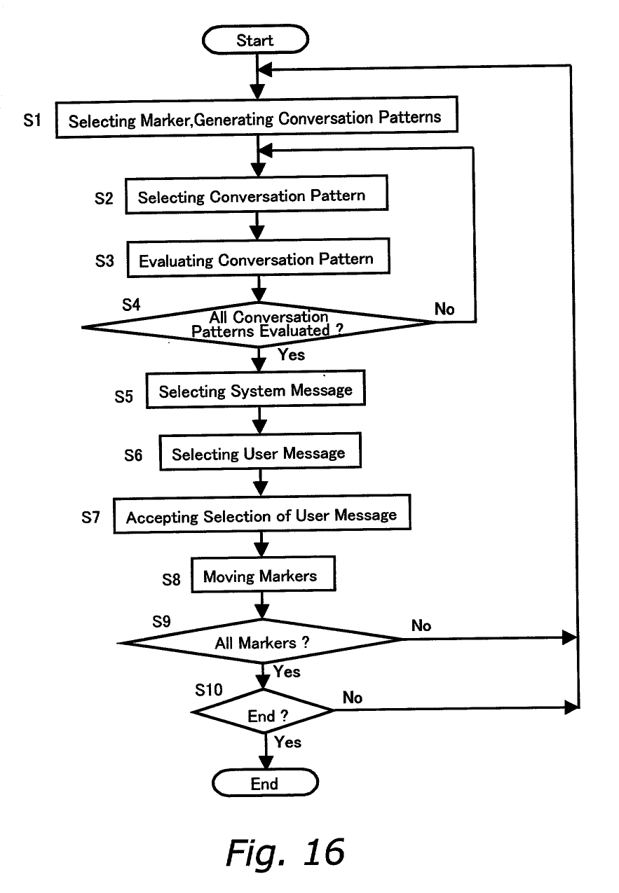

FIG. 16 is a flowchart illustrating flow of a process the control unit 13 carries out for developing conversation.

Step S1: The messaging module 131 in the control unit 13 selects a current marker that will be the marker by which a set of conversational exchanges is developed in the following steps. If the number of markers is one, that marker becomes the current marker. Then, the messaging module 131 creates context patterns based on conversation information for the current node on which the current marker is located, and on conversation information for links and nodes downstream from the current node. These context patterns include n messages leading from the current node.

Step S2: The messaging module 131 selects a context pattern that is to be evaluated in the ensuing steps.

Step S3: The messaging module 131 evaluates the selected context pattern based on the evaluation criteria and calculates the total score.

Step S4: The messaging module 131 determines whether or not evaluations have been made on all the context patterns created. If the determination is “No,” the process flow returns to step S2 and the foregoing process is repeated. If the determination “Yes,” step S5 ensues.

Step S5: The messaging module 131 selects at least one context pattern and selects the first system message included in the selected context pattern. Here, if a plurality of context patterns is selected, a new marker is created by the deciding module 134. Selected system messages are output by the GUI 2 to message windows for each marker.

Step S6: The option outputting module 132 selects according to the system message selected in step S5 at least one user message from conversation information. One way of selecting a user message is, as mentioned in section (1-3), if the system message is selected from conversation information for a node, a user message contained in the conversation information for the node or in links that issue from the node is selected. The selected user message is displayed on the screen by the GUI 2 as an option for responding to the system message.

Step S7: The selection accepting module 133 accepts from the user selection of any of the user messages displayed.

Step S8: The deciding module 134 moves the current marker according to the selected user message.

Step S9: The iterating module 135 determines whether or not the foregoing process has been executed for all markers created. If the determination is “No,” the process flow returns to step S1, the current marker is changed, and the foregoing steps are executed. If the determination is “Yes,” step S10 ensues.

Step S10: The iterating module 135 determines whether or not the process is finished. That is, the iterating module 135 determines whether or not the marker has reaches a target topic as a result of the conversation. For example, in the topic net of aforementioned FIG. 2, if the marker reaches a node in the furthest downstream-end of the topic net, it is determined that the process is finished. If the determination is “Yes,” the process ends, and if the determination is “No,” it returns to aforementioned step S1. That is, until the conversation objective is attained, the creation of context patterns corresponding to a current node, evaluation of the context patterns, and based on the evaluation result execution of conversations and movement of markers, are repeated.

Other Embodiments Examples

(A) In the foregoing first embodiment, searching for merchandise is exemplified, but the present invention can be used in other applications. For example, the invention can be used for a car navigation system. A user inputs a starting point and a destination, and selects what he/she wants to do on the way-such as “visit an art museum,” or “have a meal.” The navigation system outputs system messages based on pre-memorized road maps and embedded information. For example, system messages such as “Fujitsu art museum is located at XYZ. This art museum displays works of Ichiro Fujitsu, the great Japanese painter”; or “How about Restaurant Fujitsu?” are output. The user selects a reply in response to this. With this repetition, a route from the starting point to the destination is determined and navigation carried out according to the route.

(B) The present invention includes programs that realize the foregoing method, as well as computer-readable recording media on which the programs are recorded. As example of recording media herein, flexible discs, hard discs, semiconductor memory, CD-ROMs, DVDs, magneto-optical discs (MOs), and other computer-read/writable recording media may be cited.

Using the present invention realizes the conducting of conversations in a natural context by a computer and a user who operates it.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A conversation method for conducting conversations between a computer and a user who operates the computer, the conversation method including:
a topic net storing step of storing a topic net linking a plurality of topics;
a conversation information storing step of storing conversation information including at least one system message that is a message from the computer, at least one user message that is a message from the user and that corresponds to the system message, and a correspondence between a position in the topic net and the system message and/or the user message;
a messaging step including
a sub-step of creating potential context patterns based upon a position in the topic net of a first marker indicating a current topic in the conversation,
a sub-step of selecting at least one context pattern from the created context patterns, and
a sub-step of selecting a system message based upon the selected context pattern and outputting it;
an option outputting step including
a sub-step of selecting at least one user message based upon the position in the topic net correspondent to the selected system message, and
a sub-step of outputting the selected user message,
a selection accepting step of accepting selection of any one of the selected user messages;
a decision making step of deciding the first marker's next position in the topic net; and
an iterating step of iterating said messaging step, said option outputting step, said selection step and said decision making step.

2. The conversation method set forth by claim 1, wherein the topic net has a tree-like structure in which a link connects two nodes and thereby defines one as on the upstream end and the other as on the downstream end.

3. The conversation method set forth by claim 1, further including:
a marker creating step of creating a second marker at any position in the topic net, wherein the second marker is independent of the first marker;
an conversation executing step of executing at least two conversational exchanges on each of the first marker and the second marker, by executing said messaging step, said option outputting step, said selection accepting step, said decision making step, and said repeating step.

4. The conversation method set forth by claim 3, wherein said marker creating step creates the second marker in case two context patterns are selected among the context patterns created in said messaging step, assigns the first marker to one of the context pattern, and assigns the second marker to the other of the context patterns.

5. The conversation method set forth by claim 3, further including a merging step of merging the first marker and the second marker into one marker and merging two conversational exchanges into one conversational exchange if both the markers move to the same position in the topic net.

6. The conversation method set forth by claim 1, further including:
a topic selecting step of accepting selection of at least one topic from the user;
a creating step of creating at least one marker according to the number of topics selected in said topic selecting step;
an executing-conversational exchanges step of executing, for each of the markers created, said messaging step, said option outputting step, said selection accepting step, said decision making step, and said repeating step.

7. The conversation method set forth by claim 1, wherein the conversation information further includes at least one message type indicating a system-message category or a user message category, wherein:
said messaging step creates the context patterns based upon the message types; and
said option outputting step outputs a user message whose message type matches the system message's message type, the user message among user messages corresponding to the system message.

8. The conversation method set forth by claim 1, further including a criteria storing step of storing rating criteria for evaluating the context patterns; wherein
said messaging step evaluates created context patterns according to the rating criteria and selects at least one context pattern based upon the evaluation results.

9. The conversation method set forth by claim 1, wherein said messaging step creates context patterns that comprise system messages and user messages; wherein the total number of system messages and user messages is n (n≧2, an integer).

10. A conversation device utilized for a computer and performing conversation between the computer and a user who operates it, the conversation device comprises:
a topic net storing means for storing a topic net linking a plurality of topics;
a conversation information storing means for storing conversation information including at least one system message that is a message from the computer, at least one user message that is a message from the user and that corresponds to the system message, and a correspondence between a position in the topic net and the system message and/or the user message;
a messaging means for creating potential context patterns based upon a position in the topic net of a first marker indicating a current topic in the conversation, selecting at least one context pattern from the created context patterns, and selecting a system message based upon the selected context pattern and outputting it
an option outputting means for selecting at least one user message based upon the position in the topic net correspondent to the selected system message, and outputting the selecting user message;
a selection accepting means for accepting selection of any one of the selected user message;
a decision making means for deciding the first marker's next position in the topic net;
an iterating means for causing said messaging means, said option outputting means, said selection means and said decision making means to execute their functions repeatedly.

11. A program for making a computer function as:
a topic net storing means for storing a topic net linking a plurality of topics;
a conversation information storing means for storing conversation information including at least one system message that is a message from the computer, at least one user message that is a message from the user and that corresponds to the system message, and a correspondence between a position in the topic net and the system message and/or the user message;
a messaging means for creating potential context patterns based upon a position in the topic net of a first marker indicating a current topic in the conversation, selecting at least one context pattern from the created context patterns, and selecting a system message based upon the selected context pattern and outputting it
an option outputting means for selecting at least one user message based upon the position in the topic net correspondent to the selected system message, and outputting the selecting user message;
a selection accepting means for accepting selection of any one of the selected user message;
a decision making means for deciding the first marker's next position in the topic net;
an iterating means for causing said messaging means, said option outputting means, said selection means and said decision making means to execute their functions repeatedly.

12. A computer-readable recording medium on which is recorded a conversation program executing conversation between a computer and a user who operates it, the conversation program executes:
a topic net storing step of storing a topic net linking a plurality of topics;
a conversation information storing step of storing conversation information including at least one system message that is a message from the computer, at least one user message that is a message from the user and that corresponds to the system message, and a correspondence between a position in the topic net and the system message and/or the user message;
a messaging step including
a sub-step of creating potential context patterns based upon a position in the topic net of a first marker indicating a current topic in the conversation,
a sub-step of selecting at least one context pattern from the created context patterns, and
a sub-step of selecting a system message based upon the selected context pattern and outputting it;
an option outputting step including
a sub-step of selecting at least one user message based upon the position in the topic net correspondent to the selected system message, and
a sub-step of outputting the selected user message,
a selection accepting step of accepting selection of any one of the selected user messages;
a decision making step of deciding the first marker's next position in the topic net; and
an iterating step of iterating said messaging step, said option outputting step, said selection step and said decision making step.
